(19) United States
(12) Patent Application Publication
(10) Pub. No.: US 2026/0120242 A1
(43) Pub. Date: Apr. 30, 2026

(54) DYNAMIC ATROUS KERNEL PREDICTING NETWORK

(71) Applicant: Arm Limited, Cambridge (GB)

(72) Inventors: Ridhwanul Haque, Manchester (GB); Liam James O'Neil, Stretford (GB); Yanxiang Wang, Sale (GB)

(21) Appl. No.: 18/934,027

(22) Filed: Oct. 31, 2024

(51) Int. Cl. G06T 5/30; G06V 10/60

(52) U.S. Cl. CPC G06T 5/30; G06V 10/60; G06T 2207/20084

(57) ABSTRACT

Image signal values of an image are received as an input tensor in a kernel predicting neural network, the kernel predicting neural network trained to predict parameters for determining a plurality of sampling positions for application of an atrous filter kernel to the image. An output is provided from the kernel predicting neural network, comprising a sparse or atrous filter kernel comprising parameters for determining a plurality of sampling positions.

### FIELD

The field relates generally to neural network processing, and more specifically to using a neural network to predict a dynamic atrous kernel.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

Modern computerized devices such as smartphones perform many of the functions that were primarily performed by large desktop computers a generation ago, such as web browsing, text messaging, emailing, videoconferencing, and playing video games. Such devices increasingly employ advanced technologies such as artificial intelligence, three-dimensional rendered graphics, and the like. Apple Siri and Google Assistant are examples of voice assistants that employ artificial intelligence such as neural networks, pretrained generative transformers, and the like to enable natural language communication and provide answers to natural language questions. Three-dimensional graphics rendering pipelines also increasingly employ artificial intelligence such as neural networks to predict motion and lighting of objects, de-noise or otherwise filter rendered images, and to perform other such tasks. Augmented or virtual reality may also employ significant neural network processing to recognize objects, provide realistic rendering, and the like.

But, these artificial intelligence tools such as neural networks are often deployed on battery-powered devices with limited power and compute capacity, such as smart phones, tablet computers, or wearable electronics. Performance constraints, such as rendering image frames or filtering rendered image frames in real time with a reasonable latency are also important to delivering a quality user experience. Neural networks and other artificial intelligence tools that may perform well on a large computer may therefore need to be scaled down to perform well under the processing capacity, electrical power, and working memory constraints of devices such as smart phones.

Determining how to scale down a neural network for use on a device with limited resources while preserving the neural network's performance is a complex task. Because the neural network is typically trained using methods such as backpropagation of error and gradient descent, the explicit contribution of each node or portion of the neural network can be hard to quantify or determine. Scaling down special types of neural networks, such as a convolutional neural network kernel, may also have a significant impact on the output quality or fidelity of the network. Some networks may be downsized for use in resource-constrained computing environments by defining model accuracy constraints and acceptable latency and selecting network or filter topologies meeting both constraints, but such approaches may result in undesirable reduction in neural network performance.

For reasons such as these, a need exists for improved convolutional neural network kernel architectures meeting performance and resource constraints.

### BRIEF DESCRIPTION OF THE DRAWINGS

The claims provided in this application are not limited by the examples provided in the specification or drawings, but their organization and/or method of operation, together with features, and/or advantages may be best understood by reference to the examples provided in the following detailed description and in the drawings, in which:

FIG. 1 shows a simplified block diagram of a process using a kernel predicting neural network to predict a dynamic atrous kernel, consistent with an example embodiment

FIG. 2 shows an example atrous kernel using sampling point dilation to process an image, consistent with an example embodiment.

FIG. 3 is a more detailed flow diagram of a process using a kernel predicting neural network to predict a dynamic atrous kernel, consistent with an example embodiment.

FIG. 4 shows an example atrous kernel using sampling point dilation and an offset center luma guide signal to process an image in a convolutional neural network, consistent with an example embodiment.

FIG. 5 is a flow diagram of a method of using an atrous kernel predicted by a kernel predicting neural network to process an input tensor in a convolutional neural network, consistent with an example embodiment.

FIG. 6 is a flow diagram of a method of using offset center luma guide value to perform image processing, consistent with an example embodiment.

FIG. 7 is a schematic diagram of a neural network, consistent with an example embodiment.

FIG. 8 shows a convolutional neural network, consistent with an example embodiment.

FIG. 9 shows a block diagram of a general-purpose computerized system, consistent with an example embodiment.

Reference is made in the following detailed description to accompanying drawings, which form a part hereof, wherein like numerals may designate like parts throughout that are corresponding and/or analogous. The figures have not necessarily been drawn to scale, such as for simplicity and/or clarity of illustration. For example, dimensions of some aspects may be exaggerated relative to others. Other embodiments may be utilized, and structural and/or other changes may be made without departing from what is claimed. Directions and/or references, for example, such as up, down, top, bottom, and so on, may be used to facilitate discussion of drawings and are not intended to restrict application of claimed subject matter. The following detailed description therefore does not limit the claimed subject matter and/or equivalents.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made.

Features or limitations of various embodiments described herein, however important to the example embodiments in which they are incorporated, do not limit other embodiments, and any reference to the elements, operation, and application of the examples serve only to aid in understanding these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As neural networks are employed to perform increasingly complex tasks such as rendered image sequence processing, natural language processing, and content creation, the size and complexity of such neural networks continues to grow. Configuring neural networks that run on computing devices having limited computational resources, limited power or battery life, or limited memory often involves a compromise between architectural constraints, such as the neural network size and latency, and performance constraints, such as accuracy in predicting a desired result. In one such example, a convolutional neural network kernel used to filter an image, identify image features, or the like may have strict frames per second requirements for providing an acceptable user experience, but be constrained by the processor, memory, and battery power available on a smartphone hosting the chatbot.

Designing neural networks that provide acceptable accuracy while meeting computing environment constraints is not a trivial task, as it is difficult to understand or quantify the role that various nodes or segments of a neural network play in providing accurate predictions or outputs. Methods such as random selection or trial-and-error may be used to pare down traditional neural networks, and the size of specialty neural networks such as convolutional neural networks may be reduced such as by using smaller convolutional neural network kernels. But, because the overall fidelity or accuracy of a convolutional neural network may be strongly correlated with kernel size, simply reducing the kernel size (and therefore the receptive area or pixel area surrounding a pixel being filtered) may produce undesired results.

In one such example, using a convolutional neural network for image de-noising may strongly benefit from a relatively larger kernel receptive area, such as by reducing the influence of single noisy pixels on the overall result. If a kernel size is too small, the signal to noise ratio within a kernel window may be too low to generate acceptable results, and limit the reconstruction quality of the de-noising filter. It may also be desirable in some applications to spatially vary the kernel weight values across an image in a way that is dependent on the content being filtered, such as only applying a blurring filter if an intensity or luma value is similar to a center value. This may allow edge-aware filtering, bilateral filtering, and other filtering that may distinguish edges from other pixels in the kernel window. The size of a convolutional network kernel may similarly be varied such as based on a neural network output predicting a desired kernel size to use more computationally expensive larger kernels where a benefit might be realized, such as predicting a small kernel where pixel values in the kernel space are relatively consistent and a larger kernel size where pixel values in the kernel space have greater variation.

Some examples described herein therefore address concerns such as these by providing improved methods of applying kernels in convolutional networks, such as by using a kernel predicting network to sparsely sample the window space of a traditional convolutional network kernel. This sparse, or atrous, sampling of the kernel window may provide for coverage of an area of pixels greater than the number of sampling points, such as sampling seven points in a 5×5 kernel space, thereby saving significant processing time and resources while still sampling from a relatively large kernel window or sampling space. In a more detailed example, the sampling points may be determined via a neural network, such as by using an input image to predict sampling points, a dilation factor, or other indication of where to sample within the kernel window or sampling space. The neural network in some examples may also predict a center sampling point offset for determining a reference luma or guide signal that may be less noisy than the center sampling point in the sampling space or kernel window. The offset reference luma or guide signal may subsequently be used to determine edge-aware or other luma-based filtering parameters such as filter weights or other parameters that indicate how strongly to apply a blur filter in a sampling space.

In one specific example, a method of generating kernel sampling positions comprises receiving image signal values of an image as an input tensor in a kernel predicting neural network, where the kernel predicting neural network is trained to predict parameters for determining a plurality of sampling positions for application of an atrous filter kernel to the image. An output is provided from the kernel predicting neural network, comprising an atrous filter kernel comprising parameters for determining a plurality of sampling positions. In a further example, the parameters comprise a dilation factor to be applied to a desired number of sampling positions such that the dilation factor indicates a distance from a center sampling position at which to sample the image.

In another specific example, an apparatus comprises a kernel predicting neural network trained to predict parameters for determining a plurality of sampling positions for atrous sampling of an image in an atrous filter kernel. The kernel predicting neural network is configured to receive image signal values from an image as an input, and to provide an output comprising an atrous filter kernel comprising parameters for determining a plurality of sampling positions. In a further example, the apparatus comprises a convolutional neural network operable to filter the image using the atrous filter kernel.

In another specific example, a method comprises receiving image signal values of an image as an input in a kernel predicting neural network, where the kernel predicting neural network is trained to predict an offset for determining a center guide signal position in an atrous filter kernel. The kernel predicting neural network provides an output comprising an atrous filter kernel comprising an offset for determining the center sampling position in the image. In a further example, the offset for determining the center guide signal position comprises an offset determining a luma guide sampling position determined to have a lower noise than the center luma guide signal position based, at least in part, on luma differences between pixels in a sampling space of the atrous filter kernel.

Kernel prediction networks such as these may operate on atrous or sparse kernel spaces, sampling from a number of sampling points smaller than the number of pixels within the sampling space or kernel window. The distribution of sampling points within the kernel window may be predicted by a trained neural network, such as by providing a dilation factor or other data indicating a desired location for the sampling points. Systems and methods such as these may reduce the computational burden on convolutional neural network and kernel predicting networks by reducing the number of sampling points and computations needed to perform various functions while retaining the ability to sample the most relevant data from a sampling space or kernel window.

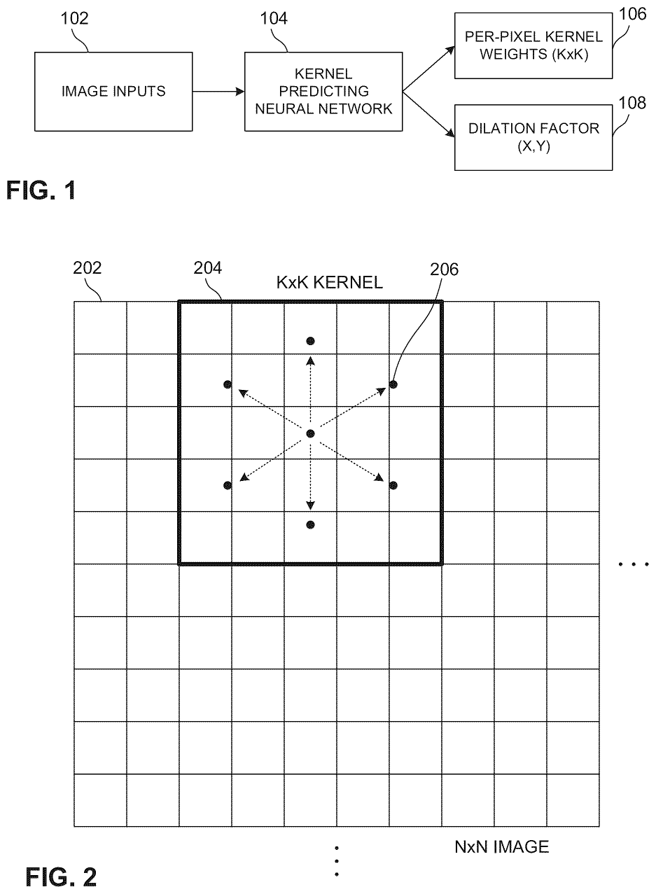

FIG. 1 shows a simplified block diagram of a process using a kernel predicting neural network to predict a dynamic atrous kernel, consistent with an example embodiment. One or more image inputs are provided at 102, such as an image to be filtered or a rendered image in a rendered image sequence such as a rendered video game, augmented reality image sequence, or the like. The one or more image inputs are provided to a trained kernel predicting network 104, which has been previously trained to predict per-pixel kernel weights 106 for image filtering, and a dilation factor 108. The per-pixel kernel weights comprise a kernel weight for sampling points in a convolutional neural network kernel, which in some examples may be an atrous or sparse kernel having fewer sampling points than the number of pixels in the sampling space or kernel window. In a more detailed example, the per-pixel kernel weights are determined for a pre-selected number of sampling points, while in alternate examples the number of sampling points may be determined by other means such as by the kernel predicting network 104 based on image inputs 102.

The physical location of the sampling points similarly may be predetermined, or may be determined using data such as the image inputs 102 via the kernel predicting neural network 104. In a more detailed example, the number of sampling points may be approximately evenly distributed around a center sampling point, and having a distance from the center sampling point in pixel units determined by the dilation factor 108. In one such example, a dilation factor of one would place the sampling points a pixel width away from the center sampling point, while a dilation factor of two would place the sampling points two pixel widths away from the center sampling point. In a further example, fractional dilation factors such as 1.34 or 2.7 may be employed, such as by using bilinear or bicubic interpolation to determine an interpolated sampling position value.

FIG. 2 shows an example atrous kernel using sampling point dilation to process an image, consistent with an example embodiment. Here, an N×N pixel image is shown generally at 202, and in typical examples may be a common smart phone or display resolution such as 1920×1080, a fraction of a common display resolution such as 960×540, or the like. A convolutional neural network kernel shown at 204 comprises a 5×5 pixel window that sweeps progressively across the image, applying a filter via a neural network to the pixel at the center of the 5×5 kernel window. Although a 5×5 kernel window is shown in this example and is typical of many applications such as image processing, 3×3 kernels and 7×7 kernels or larger may be employed in other examples with tradeoffs regarding computational efficiency vs. the number of surrounding pixels in the K×K kernel window that may influence the filtered output.

The 5×5 kernel shown at 204 of FIG. 2 includes 25 pixels in the kernel window, each of which are traditionally sampled to provide inputs to a filter to provide an output for a single central pixel. In the example shown in FIG. 2, the number of sampling points 206 is reduced to seven, including a center sampling point and six sampling points approximately equally spaced around the center sampling point. The sampling points in a further example may be a tunable parameter, such as user-specified, determined based on computational resources available, or predicted by a trained neural network. The sampling points in the example shown in FIG. 2 are evenly distributed in a circle around the center sampling point, such that only specifying a number of sampling points and a dilation factor is sufficient to determine the sampling point locations. In alternate examples, the sampling points may not be evenly distributed, but may be selected using other methods such as random selection of sampling position within the kernel window or selection based on image characteristics such as low noise, detected image features, or the like.

The six evenly-spaced sampling points surrounding the center sampling point in the example shown here are approximately 1.7 pixels away from the center sampling point, which in a further example may be determined as a 1.7 dilation factor as shown at 108 via the kernel predicting neural network 104 of FIG. 1. The dilation factor may in some examples comprise a single value, such as a constant radius as in the example here, or may comprise a different x and y scaling or dilation factor for x and y dimensions as in the example of FIG. 1. Because the sampling points shown here do not lie in the center of pixel locations, the samples may be determined such as using bilinear interpolation or other interpolation of the surrounding pixel values to determine a pixel value or values for each non-central sampling point. The samples in some more detailed examples may comprise luma (or brightness) values for red, green, and blue color channels, as are commonly used in computerized images and electronic displays. In some examples, the dilation factor may allow sampling points outside the kernel window, such as where the dilation factor is greater than half the kernel window width in pixels. Various examples may also allow for dilation factors on a per-pixel basis, or provide for other means of specifying or identifying a sampling point position.

The example of FIG. 2 no longer requires storing 25 weights (one per pixel) for the kernel prediction network at 106, or use of 25 weights in applying a convolutional neural network as is done in traditional convolutional neural networks using a traditional kernel prediction filter. Instead, only seven weights are stored at 106, and only these seven weights need to be applied to filter each pixel in the image 202 when the atrous kernel is employed in a convolutional neural network. Because the sampling points are selected by a kernel predicting neural network 104, the sampling points may be determined dynamically and adapt to image characteristics such as noise, edges, and the like. For use cases such as edge-aware filtering in a convolutional neural network, a guide or reference signal is often employed for comparison against other pixels in the kernel window, further increasing the computational burden in sampling each pixel within a kernel window or sampling space.

Application of fewer sampling points than pixels in a kernel window may be referred to as a sparse kernel or atrous kernel, and can provide an increased sampling area surrounding a pixel being filtered while decoupling the area covered by the sampling process from the number of pixels in the sampling space or kernel window. A proportional reduction in computations required and in complexity of a neural network may be achieved using an atrous kernel instead of a traditional kernel, with more substantial savings in computational cost achieved when the kernel sampling points and/or weights are determined using a kernel predicting neural network such as that of FIG. 1. Dynamic prediction of the sampling point locations, such as using the kernel predicting network to predict a dilation factor for each pixel, can dynamically identify the best areas of an image to sample. This enables the atrous kernel's sampling positions to be adjusted to avoid noise or other undesirable image artifacts identified in the kernel predicting neural network. Dynamic prediction of sampling point locations using intermediate sampling points not at the center of a single pixel can further benefit from drawing information from multiple neighboring pixels, such as where a fractional dilation factor and interpolation are used to sample the image at a sampling point 206. In a further example, the sampling points may be determined using non-neural computation, such as using algorithms in which the sampling position dilation factor and/or number of sampling positions are based on luma values of the pixels in the sampling space.

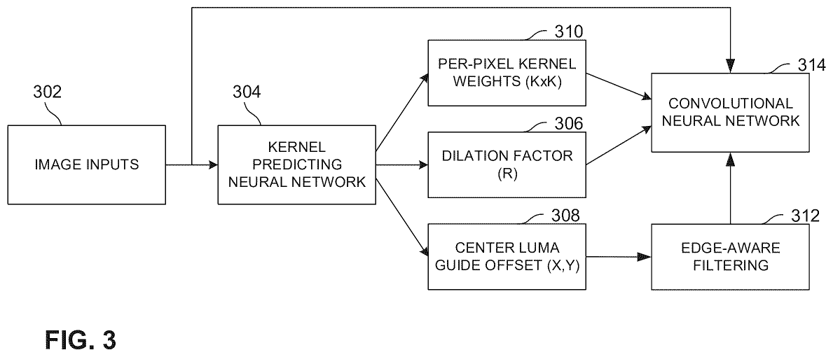

FIG. 3 is a more detailed flow diagram of a process using a kernel predicting neural network to predict a dynamic atrous kernel, consistent with an example embodiment. Here, image inputs 302 are provided to a kernel predicting neural network 304 that has been trained to predict sparse or atrous kernel sampling locations for a kernel window to be used in a convolutional neural network. The kernel predicting network in some examples may be tunable such that the number of sampling locations may be specified based on desired speed, image fidelity, or other such factors. In other examples, the number of sampling locations may be determined by the kernel predicting neural network 304 and provided as an output.

The kernel predicting network outputs per-pixel kernel weights to be used in a convolutional neural network kernel at 310, including one or more different weights for each sampling point. The kernel weights in a further example may be an importance or relevance mask or other such data used to indicate per-pixel kernel weights. The kernel predicting neural network here may be further trained to output a dilation factor as shown at 306, which in this example comprises a single radius value R. The dilation factor in other examples may comprise different offsets in different dimensions such as the x, y dimensions in the example of FIG. 2, may specify an offset in another way, or may otherwise specify the locations of the sampling points.

The kernel predicting neural network 304 in this example further outputs a center luma guide signal offset 308, which may be used to select a guide signal having a luma or brightness that is determined to be less noisy or otherwise more accurate than the center pixel. The guide signal may be used as a reference luma in various convolutional neural network applications such as edge-aware filtering, where the kernel values may be adjusted based on neighboring pixels or where filtering may be applied to a lesser degree due to the presence of an edge. This edge may be detected by sudden changes in luma value between neighboring pixels, or in a more detailed example by a change in average or typical luma value of pixels on one side of a filtered pixel relative to an opposite side of the filtered pixel. In a more detailed example, an edge-aware filter 312 such as a joint bilateral filter may be employed using luma delta or luma difference between the center pixel and other pixels as a guide. Pixels with a higher difference in luma relative to the guide signal or guide pixel may therefore have a smaller contribution to the overall output value of the filter for the center pixel. In examples where the center pixel is noisy, this may result in inaccurate application of the filter and bias the luma delta guide algorithm to give more weight to similarly noisy pixels. If the pixel being filtered is determined to be noisy in the kernel predicting neural network 304, the location used as a guide signal may be offset to a less noisy location using the center luma guide offset as shown at 308. The offset center luma guide signal may then be used to more accurately perform edge-aware or other image feature-aware filtering in a convolutional neural network. The output pixel remains at the original center pixel location, and may effectively be de-noised using methods such as these.

The per-pixel kernel weights 310, dilation factor 306, and edge-aware filtering based on the center luma guide offset 308 may be provided to convolutional neural network 314, which may use the provided kernel information to filter the image inputs using a convolutional neural network as described in the examples herein. Although the example shown here may perform various filtering or image processing functions on images, other examples may use convolutional neural networks, atrous kernels, sampling point dilation, and other methods described herein to perform other functions such as object detection, image creation, natural language processing, self-driving or autonomous machine operation, or other such applications.

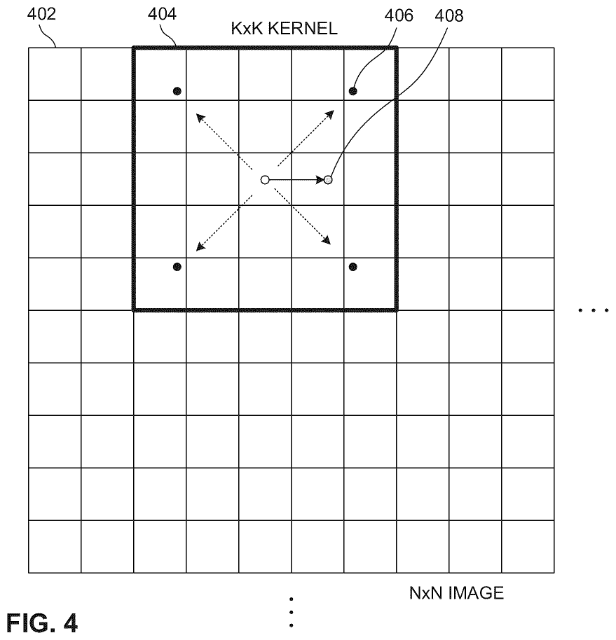

FIG. 4 shows an example atrous kernel using sampling point dilation and an offset center luma guide signal to process an image, consistent with an example embodiment. Here, an N×N image shown at 402 may be processed using a K×K kernel window shown at 404, much as in the example of FIG. 2. The example shown here has five sampling points as shown at 408 rather than the seven sampling points in the example of FIG. 2, and the sampling points are dilated farther from the center (approximately 3.4 pixel widths) than the sampling points in FIG. 2. The four sampling points in FIG. 4 that are a dilated distance from the center sampling point are also each located near the corners of a pixel, such that a graphics engine's bilinear interpolation engine may be used to efficiently interpolate between the pixel in which the sampling point resides and the three neighboring pixels. This interpolation may significantly improve the amount of pixel data that can be captured with a relatively small number of sampling points, such as five sampling points in the example shown here rather than the 25 sampling points that would commonly be sampled for a 5×5 kernel size.

The atrous kernel having five sampling points as shown here further shows use of an offset center luma guide signal at 408, indicating that the kernel prediction filter has predicted that the center pixel may be noisy and that an offset center luma guide position may provide a more accurate or less noisy reference luma level for certain processes such as edge detection and de-noising where a guide or reference luma level may be useful. The offset in some examples may be to a neighboring pixel, such as an integer x, y offset value, while in other examples may comprise a fractional value such as 1.2, 0.0 as shown in the example of FIG. 4.

Fractional offset values may be processes by using bilinear interpolation between neighboring pixels, such as between the pixel and a neighboring pixel where a coordinate position of the offset center luma guide sampling position does not lie at the middle of a pixel. In the example of FIG. 4, bilinear interpolation between at least the pixel in which the offset sampling position resides and the pixel to its immediate right may provide a more accurate guide luma level than a single pixel alone, allowing the luma guide signal to benefit from the influence of more than one pixel in the kernel window. The offset center luma guide position may lie outside the kernel window in other examples, such as being offset by more than 1.5 pixel widths when using a 3×3 kernel window.

The offset center luma guide signal may be used in some examples for filtering, such as ray tracing de-noising using a joint bilateral filter with a luma guide signal. Pixels with a higher difference in luma with respect to the offset center luma guide signal may have a lower contribution to the overall output value of such a de-noising filter, but such a process may be dependent on having an accurate luma guide signal level to avoid inadvertently emphasizing the contribution of other noisy pixels in the filtering process. In other examples, guide signals other than luma values may be used as a guide signal or to determine the selected guide signal, such as RGB color values, depth values, difference calculations, or the like.

Although the guide signal sampling offsets in the above example are offset using a neural network to estimate a sampling offset for a guide signal to be used in a secondary edge-aware filtering stage, other examples may similarly use predicted sampling offsets for other purposes. In one such example the offset may be employed within a neural network itself, such as where offsets are applied to deep features such as activation functions in the neural network rather than to image content. In another such example, the guide signal offset may be derived using non-neural means, such as luma variance calculations, which in a further example may also be used to derive a dilation factor as in the example of FIG. 2.

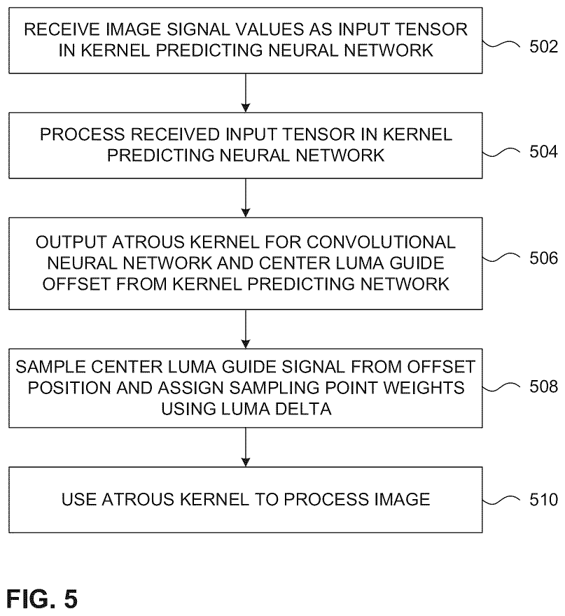

FIG. 5 is a flow diagram of a method of using an atrous kernel predicted by a kernel predicting neural network to process an input tensor in a convolutional neural network, consistent with an example embodiment. At 502, an input tensor such as image signal values, natural language processing input, or other such input tensors are received in a kernel predicting neural network, often simply called a kernel predicting network. The kernel predicting network has been previously trained to predict one or more outputs based on the input tensor, such as sparse or atrous kernel sampling positions, kernel weights for the sampling positions, a center luma guide signal offset, and/or other such outputs.

The kernel predicting neural network processes the received input tensor at 504, and provides one or more output tensors based on its previous training. In the example of FIG. 5, the output tensors include providing an atrous kernel having fewer sampling points than pixels in a kernel window at 506, as well as a center luma guide offset. The atrous kernel in a more detailed example comprises one or more indications of sampling positions, such as a dilation factor or diameter in pixel widths from the center of the kernel window for individual or all sampling locations, and in a further example includes kernel weights for the sampling locations. The number of sampling locations may in various examples be a software-tunable parameter of the kernel predicting neural network, or may be provided as an output tensor of the kernel predicting neural network. The center luma guide offset may be provided as an x, y offset in pixel widths from the center of the kernel window, or may comprise another indication of an offset luma guide signal location, such as in the examples described in conjunction with FIG. 4.

The center luma guide offset position is used to sample a center luma guide value at 508, such as may be used in de-noising, joint bilateral filtering, or other processing where a reference or guide signal value may be useful. The atrous kernel from 506, the input image signal values from 502, and in a further example a set of edge-aware sampling point weights derived using the offset sampled center luma guide signal are used at 510 to process the image, such as to filter an image, identify features within an image, provide guidance data for a self-driving vehicle, or perform another such function.

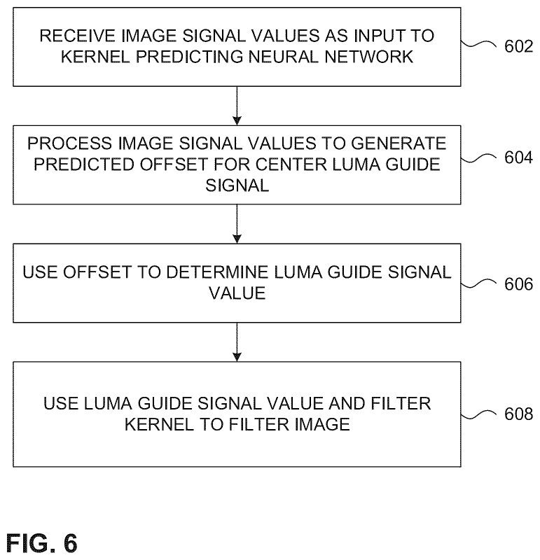

FIG. 6 is a flow diagram of a method of using offset center luma guide value to perform image processing, consistent with an example embodiment. Here, image signal values are received as an input tensor to a kernel predicting neural network at 602. In an alternate example, a neural network other than a kernel predicting neural network may be employed, such as another network trained to predict a luma guide signal offset.

The received image signal values are processed in the kernel predicting neural network at 604 to generate a predicted offset for a center luma guide signal. In some examples, the predicted offset may be an offset from a center position in a convolutional neural network kernel, while in other examples the predicted offset may be another output tensor value indicating the position or relative position of the offset center luma guide signal, such as x, y values within the kernel window. The offset is used at 606 to determine a luma guide signal value, such as for joint bilateral filtering in a convolutional neural network image de-noising filter or other such convolutional neural network application that may benefit from a reference or guide signal value such as to calculate deltas between the guide value and individual sampling location values to weight the influence of the individual sampling location values on the output.

The luma guide signal value and a filter kernel output from the kernel predicting neural network are used at 608 to filter or process the image at 608, such as in the examples of FIG. 4 and other examples presented herein. Use of an offset luma guide signal and luma differences between the guide signal and sampling locations to determine sampling location weights may improve the performance of the image processing filter and convolutional network if the offset luma guide signal is lower noise than the center sampling location. The kernel predicting neural network or other neural network employed at 602 and 604 in some examples may therefore be trained to recognize noisy center sampling position luma, and to determine an offset representing a less noisy sampling position for a luma guide signal.

The examples presented herein demonstrate how use of an atrous kernel or sparse kernel can significantly reduce the computational burden in a convolutional neural network, while preserving image quality and processing or filtering fidelity. Use of an offset luma guide signal for certain applications may further help ensure that a noisy center luma signal value is not used as a guide signal for performing various filter functions, improving the effectiveness of functions such as de-noising using a joint bilateral edge-aware filter. Many examples presented herein may employ neural networks, convolutional neural networks, and other computerized or electronic data processing elements such as are described in the examples below.

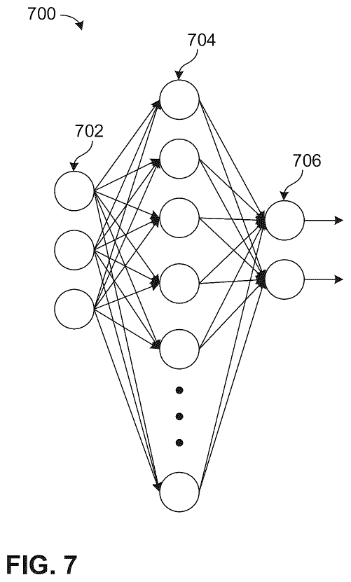

FIG. 7 is a schematic diagram of a neural network 700 formed in “layers” in which an initial layer is formed by nodes 702 and a final layer is formed by nodes 706. All or a portion of features of neural network 700 may be implemented various embodiments of systems described herein. Neural network 700 may include one or more intermediate layers, shown here by intermediate layer of nodes 704. Edges shown between nodes 702 and 704 illustrate signal flow from an initial layer to an intermediate layer. Likewise, edges shown between nodes 704 and 706 illustrate signal flow from an intermediate layer to a final layer. Although FIG. 7 shows each node in a layer connected with each node in a prior or subsequent layer to which the layer is connected, i.e., the nodes are fully connected, other neural networks will not be fully connected but will employ different node connection structures. While neural network 700 shows a single intermediate layer formed by nodes 804, other implementations of a neural network may include multiple intermediate layers formed between an initial layer and a final layer.

According to an embodiment, a node 702, 704 and/or 706 may process input signals (e.g., received on one or more incoming edges) to provide output signals (e.g., on one or more outgoing edges) according to an activation function. An “activation function” as referred to herein means a set of one or more operations associated with a node of a neural network to map one or more input signals to one or more output signals. In a particular implementation, such an activation function may be defined based, at least in part, on a weight associated with a node of a neural network. Operations of an activation function to map one or more input signals to one or more output signals may comprise, for example, identity, binary step, logistic (e.g., sigmoid and/or soft step), hyperbolic tangent, rectified linear unit, Gaussian error linear unit, Softplus, exponential linear unit, scaled exponential linear unit, leaky rectified linear unit, parametric rectified linear unit, sigmoid linear unit, Swish, Mish, Gaussian and/or growing cosine unit operations. It should be understood, however, that these are merely examples of operations that may be applied to map input signals of a node to output signals in an activation function, and claimed subject matter is not limited in this respect.

Additionally, an “activation input value” as referred to herein means a value provided as an input parameter and/or signal to an activation function defined and/or represented by a node in a neural network. Likewise, an “activation output value” as referred to herein means an output value provided by an activation function defined and/or represented by a node of a neural network. In a particular implementation, an activation output value may be computed and/or generated according to an activation function based on and/or responsive to one or more activation input values received at a node. In a particular implementation, an activation input value and/or activation output value may be structured, dimensioned and/or formatted as “tensors”. Thus, in this context, an “activation input tensor” as referred to herein means an expression of one or more activation input values according to a particular structure, dimension and/or format. Likewise in this context, an “activation output tensor” as referred to herein means an expression of one or more activation output values according to a particular structure, dimension and/or format.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, Internet of things (IoT) devices, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

A neural network may be structured in layers, such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another class of layered neural network may comprise a recurrent neural network (RNN) that is a class of neural networks in which connections between nodes form a directed cyclic graph along a temporal sequence. Such a temporal sequence may enable modeling of temporal dynamic behavior. In an implementation, an RNN may employ an internal state (e.g., memory) to process variable length sequences of inputs. This may be applied, for example, to tasks such as unsegmented, connected handwriting recognition or speech recognition, just to provide a few examples. In particular implementations, an RNN may emulate temporal behavior using finite impulse response (FIR) or infinite impulse response (IIR) structures. An RNN may include additional structures to control stored states of such FIR and IIR structures to be aged. Structures to control such stored states may include a network or graph that incorporates time delays and/or has feedback loops, such as in long short-term memory networks (LSTMs) and gated recurrent units.

According to an embodiment, output signals of one or more neural networks (e.g., taken individually or in combination) may at least in part, define a “predictor” to generate prediction values associated with some observable and/or measurable phenomenon and/or state. In an implementation, a neural network may be “trained” to provide a predictor that is capable of generating such prediction values based on input values (e.g., measurements and/or observations) optimized according to a loss function. For example, a training process may employ backpropagation techniques to iteratively update neural network weights to be associated with nodes and/or edges of a neural network based, at least in part on “training sets.” Such training sets may include training measurements and/or observations to be supplied as input values that are paired with “ground truth” observations or expected outputs. Based on a comparison of such ground truth observations and associated prediction values generated based on such input values in a training process, weights may be updated according to a loss function using backpropagation. The neural networks employed in various examples can be any known or future neural network architecture, including traditional feed-forward neural networks, convolutional neural networks, or other such networks.

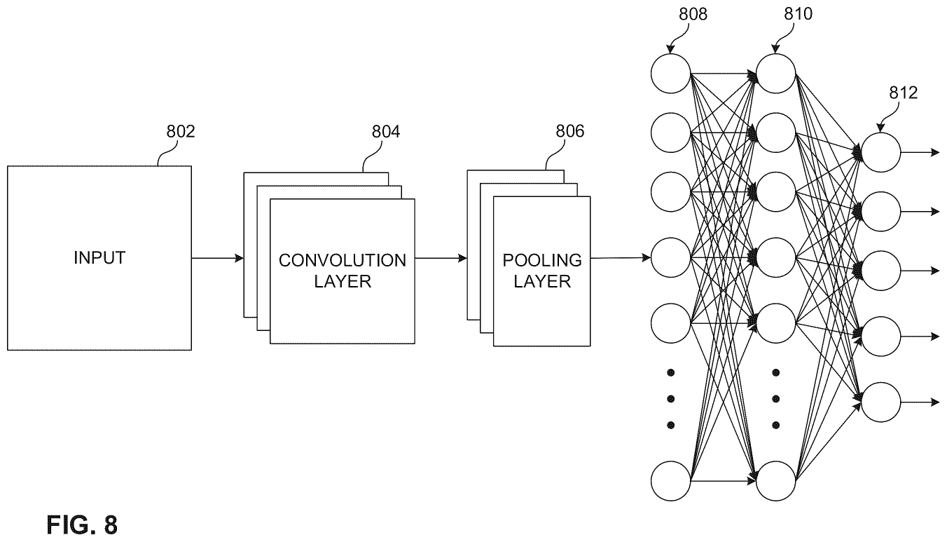

FIG. 8 shows a convolutional neural network, consistent with an example embodiment. A convolutional neural network is configured to recognize the importance of information in one input region relative to inputs in other input regions, such as the pixels around an object being filtered rather than pixels in a remote part of the image. Because spatial and temporal relatedness are built in to various convolutional neural network configurations, the convolutional neural network does not have to learn the importance of this relatedness as it would in a simple flattened backpropagation neural network and is more efficient.

In FIG. 8, the input 802 comprises an image which in this example is a 256×256 image in an RGB color space, having pixel locations arranged in a two-dimensional grid with three channels of color intensity or brightness (one channel each for red, green, and blue light). When performing image processing functions such as sharpening, blurring, de-noising, or the like, pixels immediately surrounding an image area being altered are most relevant to alteration of the image area, as are pixels in corresponding locations in each of the three color channels.

Convolution layer 804 comprises a kernel value derived from the image for the kernel region surrounding pixels in the original image, such as using a 3×3 kernel filter of nine pixels configured to include each original pixel as well as the eight pixels surrounding the original pixel. As the kernel filter is swept across the original image, an element-wise multiplication of the kernel filter and the image values is performed for each location, and a sum of each element in the product matrix is stored in the convolution layer 804. The kernel filter in some examples will weight each element equally, such as by having ones as multipliers in each element of the 3×3 kernel filter, but in other examples will weight elements differently by having different multipliers for different elements. Because the original image provided as an input at 802 is 256×256 and it is swept by a kernel filter of 3×3 that does not sweep outside the bounds of the original image, the output stored in convolution layer 804 is a matrix of size 254×254 in three channels. In another example, the original image is padded on all sides with a value such as zeros or with repeated border values to increase the input size to 258×258 before sweeping with the 3×3 kernel filter, resulting in an output stored in convolution layer 804 of 256×256 (the original input size). In some alternate examples, the three channels representing red, blue, and green colors are combined in a single channel, or in a fourth channel in addition to the three color channels.

Pooling layer 806 is configured to reduce the spatial size of the convolved features in convolution layer 804, which provides the benefit of reducing the computational power required to process the data. Pooling again involves sweeping the prior data structure with a kernel to produce a new data structure, such as sweeping the convolution layer matrix 804 with a 3×3 kernel. Common pooling algorithms include max pooling, in which the maximum value in the 3×3 kernel or window sweeping the convolution layer is recorded for each windowed location in the convolution layer, and average pooling, in which the average value in the 3×3 kernel sweeping the convolution layer is recorded for each swept location. Max pooling removes noise from data well, and is often preferred over average pooling in which dimensionality reduction is the primary effect.

The kernel in the pooling step in some examples is of different size than the kernel in the convolution layer step, and in another example strides or sweeps across the input data matrix by more than one element at a time. In one such example a 2×2 kernel is used in the pooling step, with a stride of two in each dimension, such that each data element in the convolution layer contributes to only one element in the pooling layer which is approximately one-fourth the size of the convolution layer. In further examples, one or more additional layers or variations on the convolution layer and/or the pooling layer are employed, and may be beneficial to reducing the computational power needed to recognize various elements or features in the input data 902. For example, the convolution and pooling layers may be repeated to further reduce the input data before further processing.

The pooling layer 806 is then flattened in flattened layer 808, for processing in a traditional feed-forward neural network comprising one or more intermediate layers as shown at 810. In a more detailed example, the feed-forward layers are fully connected, meaning each node in an intermediate layer is connected to each node in preceding and subsequent layers, and uses a nonlinear activation function such as the ReLU (rectified linear) or similar activation function. In other examples, the feed-forward layers are not fully connected, but use other node connection topologies.

The output 812 in the example of FIG. 8 comprises a soft-max activation function, in which the input image at 802 is classified as being one of five different possible outputs, such as an image of the letter A, B, C, D, or E. Practical convolutional neural networks often have significantly larger inputs and outputs than the example presented, here, and can perform more complex recognition or other filtering tasks at the expense of greater network complexity.

The convolutional neural network's input, output, and intermediate data sets are often referred to as “tensors”, which can have multiple dimensions or “ranks” depending on the data type, dimensionality, and number of channels in the data set. Vectors within a tensor represent related data elements, such as data set of 100 stocks having 365 daily closing prices in which 100 vectors of 365 elements each are stored in a 100×365 tensor denoted as (100,365). Complex data such as video may have many dimensions of related data, such as where a two-dimensional image of 1920×1080 plus color depth of 256 plus frame number in the video sequence of 10,000 comprise a four dimensional tensor (10000,1920,1080,256). Examples such as these illustrate the benefit of feature recognition and data reduction in a convolutional neural network before processing in a feed-forward neural network to make efficient use of processing power.

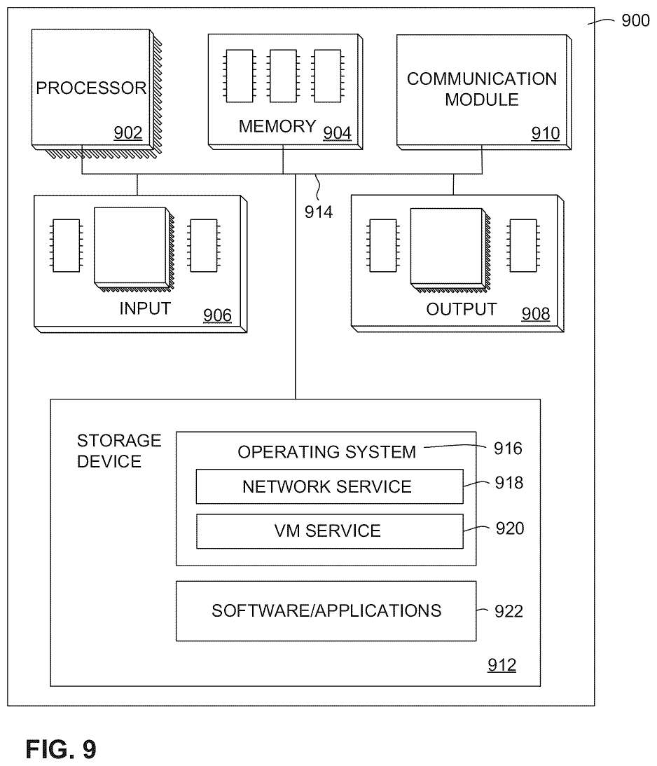

FIG. 9 shows a block diagram of a general-purpose computerized system, consistent with an example embodiment. FIG. 9 illustrates only one particular example of computing device 900, and other computing devices 900 may be used in other embodiments. Although computing device 900 is shown as a standalone computing device, computing device 900 may be any component or system that includes one or more processors or another suitable computing environment for executing software instructions in other examples, and need not include all of the elements shown here.

As shown in the specific example of FIG. 9, computing device 900 includes one or more processors 902, memory 904, one or more input devices 906, one or more output devices 1008, one or more communication modules 910, and one or more storage devices 912. Computing device 900, in one example, further includes an operating system 916 executable by computing device 900. The operating system includes in various examples services such as a network service 918 and a virtual machine service 920 such as a virtual server. One or more applications such as software application 1022 are also stored on storage device 1012, and are executable by computing device 1000.

Each of components 902, 904, 906, 908, 910, and 912 may be interconnected (physically, communicatively, and/or operatively) for inter-component communications, such as via one or more communications channels 914. In some examples, communication channels 914 include a system bus, network connection, inter-processor communication network, or any other channel for communicating data. Applications such as application 922 and operating system 916 may also communicate information with one another as well as with other components in computing device 900.

Processors 902, in one example, are configured to implement functionality and/or process instructions for execution within computing device 900. For example, processors 902 may be capable of processing instructions stored in storage device 912 or memory 904. Examples of processors 902 include any one or more of a microprocessor, a controller, a central processing unit (CPU), a graphics processing unit (GPU), a neural processing unit (NPU), an image signal processor (ISP), a digital signal processor (DSP), an application specific integrated circuit (ASIC), a field-programmable gate array (FPGA), or similar discrete or integrated logic circuitry.

One or more storage devices 912 may be configured to store information within computing device 900 during operation. Storage device 912, in some examples, is known as a computer-readable storage medium. In some examples, storage device 912 comprises temporary memory, meaning that a primary purpose of storage device 912 is not long-term storage. Storage device 912 in some examples is a volatile memory, meaning that storage device 912 does not maintain stored contents when computing device 900 is turned off. In other examples, data is loaded from storage device 912 into memory 904 during operation. Examples of volatile memories include random access memories (RAM), dynamic random access memories (DRAM), static random access memories (SRAM), and other forms of volatile memories known in the art. In some examples, storage device 912 is used to store program instructions for execution by processors 902. Storage device 912 and memory 904, in various examples, are used by software or applications running on computing device 900 such as application 922 to temporarily store information during program execution.

Storage device 912, in some examples, includes one or more computer-readable storage media that may be configured to store larger amounts of information than volatile memory. Storage device 912 may further be configured for long-term storage of information. In some examples, storage devices 912 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 900, in some examples, also includes one or more communication modules 910. Computing device 900 in one example uses communication module 910 to communicate with external devices via one or more networks, such as one or more wireless networks. Communication module 910 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 900 uses communication module 910 to wirelessly communicate with an external device such as via a public network such as the Internet.

Computing device 900 also includes in one example one or more input devices 906. Input device 906, in some examples, is configured to receive input from a user through tactile, audio, or video input. Examples of input device 906 include a touchscreen display, a mouse, a keyboard, a voice responsive system, video camera, microphone or any other type of device for detecting input from a user.

One or more output devices 908 may also be included in computing device 900. Output device 908, in some examples, is configured to provide output to a user using tactile, audio, or video stimuli. Output device 908, in one example, includes a display, a sound card, a video graphics adapter card, or any other type of device for converting a signal into an appropriate form understandable to humans or machines. Additional examples of output device 1008 include a speaker, a light-emitting diode (LED) display, a liquid crystal display (LCD or OLED), or any other type of device that can generate output to a user.

Computing device 900 may include operating system 916. Operating system 916, in some examples, controls the operation of components of computing device 900, and provides an interface from various applications such as application 922 to components of computing device 800. For example, operating system 916, in one example, facilitates the communication of various applications such as federated learning module 922 with processors 902, communication unit 910, storage device 912, input device 906, and output device 908. Applications such as federated learning module 922 may include program instructions and/or data that are executable by computing device 900. These and other program instructions or modules may include instructions that cause computing device 900 to perform one or more of the other operations and actions described in the examples presented herein.

Features of example computing devices such as those shown in FIG. 9 may comprise features, for example, of a client computing device and/or a server computing device, in an embodiment. It is further noted that the term computing device, in general, whether employed as a client and/or as a server, or otherwise, refers at least to a processor and a memory connected by a communication bus. A “processor” and/or “processing circuit” for example, is understood to connote a specific structure such as a central processing unit (CPU), digital signal processor (DSP), graphics processing unit (GPU), image signal processor (ISP) and/or neural processing unit (NPU), or a combination thereof, of a computing device which may include a control unit and an execution unit. In an aspect, a processor and/or processing circuit may comprise a device that fetches, interprets and executes instructions to process input signals to provide output signals. As such, in the context of the present patent application at least, this is understood to refer to sufficient structure within the meaning of 35 USC § 112 (f) so that it is specifically intended that 35 USC § 112 (f) not be implicated by use of the term “computing device,” “processor,” “processing unit,” “processing circuit” and/or similar terms; however, if it is determined, for some reason not immediately apparent, that the foregoing understanding cannot stand and that 35 USC § 112 (f), therefore, necessarily is implicated by the use of the term “computing device” and/or similar terms, then, it is intended, pursuant to that statutory section, that corresponding structure, material and/or acts for performing one or more functions be understood and be interpreted to be described at least in FIG. 1 and in the text associated with the foregoing figure(s) of the present patent application.

The term electronic file and/or the term electronic document, as applied herein, refer to a set of stored memory states and/or a set of physical signals associated in a manner so as to thereby at least logically form a file (e.g., electronic) and/or an electronic document. That is, it is not meant to implicitly reference a particular syntax, format and/or approach used, for example, with respect to a set of associated memory states and/or a set of associated physical signals. If a particular type of file storage format and/or syntax, for example, is intended, it is referenced expressly. It is further noted an association of memory states, for example, may be in a logical sense and not necessarily in a tangible, physical sense. Thus, although signal and/or state components of a file and/or an electronic document, for example, are to be associated logically, storage thereof, for example, may reside in one or more different places in a tangible, physical memory, in an embodiment.

In the context of the present patent application, the terms “entry,” “electronic entry,” “document,” “electronic document,” “content,”, “digital content,” “item,” and/or similar terms are meant to refer to signals and/or states in a physical format, such as a digital signal and/or digital state format, e.g., that may be perceived by a user if displayed, played, tactilely generated, etc. and/or otherwise executed by a device, such as a digital device, including, for example, a computing device, but otherwise might not necessarily be readily perceivable by humans (e.g., if in a digital format).

Also, for one or more embodiments, an electronic document and/or electronic file may comprise a number of components. As previously indicated, in the context of the present patent application, a component is physical, but is not necessarily tangible. As an example, components with reference to an electronic document and/or electronic file, in one or more embodiments, may comprise text, for example, in the form of physical signals and/or physical states (e.g., capable of being physically displayed). Typically, memory states, for example, comprise tangible components, whereas physical signals are not necessarily tangible, although signals may become (e.g., be made) tangible, such as if appearing on a tangible display, for example, as is not uncommon. Also, for one or more embodiments, components with reference to an electronic document and/or electronic file may comprise a graphical object, such as, for example, an image, such as a digital image, and/or sub-objects, including attributes thereof, which, again, comprise physical signals and/or physical states (e.g., capable of being tangibly displayed). In an embodiment, digital content may comprise, for example, text, images, audio, video, and/or other types of electronic documents and/or electronic files, including portions thereof, for example.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

Some embodiments may be described, at least in part, by the following numbered clauses or by any combination thereof:

Clause 1: A method, comprising: receiving image signal values of an image as an input tensor in a kernel predicting neural network, the kernel predicting neural network trained to predict parameters for determining a plurality of sampling positions for application of an atrous filter kernel to the image; and providing an output from the kernel predicting neural network, the output comprising an atrous filter kernel comprising parameters for determining a plurality of sampling positions.

Clause 2: The method of clause 1, further comprising filtering the image using the atrous filter kernel in a convolutional neural network.

Clause 3: The method of any of the aforementioned clauses, wherein the parameters for determining a plurality of sampling positions comprise a dilation factor.

Clause 4: The method of any of the aforementioned clauses, wherein parameters for determining a plurality of sampling positions comprises determining sampling positions such that at least some pixel locations in an atrous filter kernel space are not sampled.

Clause 5: The method of any of the aforementioned clauses, wherein at least one of the parameters for determining a plurality of sampling positions comprise parameters for determining sampling position between pixel locations.

Clause 6: The method of clause 5, further comprising interpolating between sampling positions that are between pixel locations.

Clause 7: The method of any of the aforementioned clauses, wherein output from the kernel predicting network output further comprises weights for the determined plurality of sampling positions in the atrous filter kernel.

Clause 8: The method of any of the aforementioned clauses, wherein the parameters for determining a plurality of sampling positions comprise an offset for a center luma guide signal position of the atrous filter kernel.

Clause 9: The method of clause 8, wherein the offset center luma guide signal comprises a luma guide signal determined to have a lower noise than a center luma sampling position based, at least in part, on luma differences between pixels in a sampling space of the atrous filter kernel.

Clause 10: An apparatus, comprising: a kernel predicting neural network trained to predict parameters for determining a plurality of sampling positions for atrous sampling of an image in an atrous filter kernel, the kernel predicting neural network further configured to receive image signal values from an image as an input and to provide an output comprising an atrous filter kernel comprising parameters for determining a plurality of sampling positions.

Clause 11: The apparatus of clause 10, further comprising a convolutional neural network operable to filter the image using the atrous filter kernel.

Clause 12: The apparatus of clause 11, wherein at least one of the parameters for determining a plurality of sampling positions comprises a parameter determining a sampling position between pixel locations, and the convolutional neural network is further operable to filter the image by using bilinear filtering to interpolate between determined sampling positions that are between pixel locations.

Clause 13: The apparatus of any of clauses 10-12, wherein the parameters for determining a plurality of sampling positions comprise a dilation factor.

Clause 14: The apparatus of any of clauses 10-13, wherein atrous sampling comprises sampling such that at least some pixel locations in an atrous convolutional filter kernel space are not sampled.

Clause 15: The apparatus of any of clauses 10-14, wherein the output from the kernel predicting network further comprises weights for the atrous filter kernel's determined plurality of sampling positions.

Clause 16: The apparatus of any of clauses 10-15, wherein the parameters for determining a plurality of sampling positions further comprise an offset for a center luma guide signal position of the atrous filter kernel.

Clause 17: The apparatus of clause 16, wherein the offset luma guide signal position comprises a luma guide signal determined to have a lower noise than a center luma sampling position based, at least in part, on luma differences between pixels in a sampling space of the atrous filter kernel.

Clause 18: A method, comprising: receiving image signal values of an image as an input in a kernel predicting neural network, the kernel predicting neural network trained to predict an offset for determining a center luma guide signal position in an atrous filter kernel; and providing an output from the kernel predicting neural network, the output comprising an atrous filter kernel comprising an offset for determining the center luma sampling position in the image.

Clause 19: The method of clause 18, wherein the offset for determining the center luma guide signal position comprises an offset determining a luma guide sampling position determined to have a lower noise than the center luma guide signal position based, at least in part, on luma differences between pixels in a sampling space of the atrous filter kernel.

Clause 20: The method of any of clauses 18-19, the output from the kernel predicting neural network further comprising an atrous filter kernel comprising parameters for determining a plurality of sampling positions for filtering the image, the kernel predicting neural network trained to predict the parameters for determining the plurality of sampling positions for filtering the image using the atrous filter kernel.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

What is claimed is:

1. A method, comprising:
receiving image signal values of an image as an input tensor in a kernel predicting neural network, the kernel predicting neural network trained to predict parameters for determining a plurality of sampling positions for application of an atrous filter kernel to the image; and
providing an output from the kernel predicting neural network, the output comprising an atrous filter kernel comprising parameters for determining a plurality of sampling positions.

2. The method of claim 1, further comprising filtering the image using the atrous filter kernel in a convolutional neural network.

3. The method of claim 1, wherein the parameters for determining a plurality of sampling positions comprise a dilation factor.

4. The method of claim 1, wherein parameters for determining a plurality of sampling positions comprises determining sampling positions such that at least some pixel locations in an atrous filter kernel space are not sampled.

5. The method of claim 1, wherein at least one of the parameters for determining a plurality of sampling positions comprise parameters for determining sampling position between pixel locations.

6. The method of claim 5, further comprising interpolating between sampling positions that are between pixel locations.

7. The method of claim 1, wherein output from the kernel predicting network output further comprises weights for the determined plurality of sampling positions in the atrous filter kernel.

8. The method of claim 1, wherein the parameters for determining a plurality of sampling positions comprise an offset for a center luma guide signal position of the atrous filter kernel.

9. The method of claim 8, wherein the offset for a center luma guide signal comprises a luma guide signal determined to have a lower noise than a center luma sampling position based, at least in part, on luma differences between pixels in a sampling space of the atrous filter kernel.

10. An apparatus, comprising:
a kernel predicting neural network trained to predict parameters for determining a plurality of sampling positions for atrous sampling of an image in an atrous filter kernel, the kernel predicting neural network further configured to receive image signal values from an image as an input and to provide an output comprising an atrous filter kernel comprising parameters for determining a plurality of sampling positions.

11. The apparatus of claim 10, further comprising a convolutional neural network operable to filter the image using the atrous filter kernel.

12. The apparatus of claim 11, wherein at least one of the parameters for determining a plurality of sampling positions comprises a parameter determining a sampling position between pixel locations, and the convolutional neural network is further operable to filter the image by using bilinear filtering to interpolate between determined sampling positions that are between pixel locations.

13. The apparatus of claim 10, wherein the parameters for determining a plurality of sampling positions comprise a dilation factor.

14. The apparatus of claim 10, wherein atrous sampling comprises sampling such that at least some pixel locations in an atrous convolutional filter kernel space are not sampled.

15. The apparatus of claim 10, wherein the output from the kernel predicting neural network further comprises weights for application at the determined plurality of sampling positions.

16. The apparatus of claim 10, wherein the parameters for determining a plurality of sampling positions further comprise an offset for a center luma guide signal position of the atrous filter kernel.

17. The apparatus of claim 16, wherein the offset for the center luma guide signal position comprises a luma guide signal determined to have a lower noise than a center luma sampling position based, at least in part, on luma differences between pixels in a sampling space of the atrous filter kernel.

18. A method, comprising:
receiving image signal values of an image as an input in a kernel predicting neural network, the kernel predicting neural network trained to predict an offset indicating a center guide signal position in an atrous filter kernel; and
providing an output from the kernel predicting neural network, the output comprising an atrous filter kernel comprising an offset indicating the center guide signal position in the image.

19. The method of claim 18, wherein the guide signal comprises a luma guide signal, and the offset for determining the center guide signal position comprises an offset determining a guide sampling position determined to have a lower noise than the center guide signal position based, at least in part, on luma differences between pixels in a sampling space of the atrous filter kernel.

20. The method of claim 18, the output from the kernel predicting neural network further comprising an atrous filter kernel comprising parameters for determining a plurality of sampling positions for filtering the image, the kernel predicting neural network trained to predict the parameters for determining the plurality of sampling positions for filtering the image using the atrous filter kernel.
